(19) United States
(12) Patent Application Publication
(10) Pub. No.: US 2025/0162663 A1
(43) Pub. Date: May 22, 2025

(54) MOUNTING AND SEALING ASSEMBLY

(71) Applicant: L&H Industrial, Inc., Gillette, WY (US)

(72) Inventors: James Lee Meinen, Gillette, WY (US); Jordan T. Rhodine, Gillette, WY (US); Clark David Christenson, Gillette, WY (US)

(73) Assignee: L&H Industrial, Inc., Gillette, WY (US)

(21) Appl. No.: 18/512,494

(22) Filed: Nov. 17, 2023

(51) Int. Cl. B62D 55/15; B62D 55/088

(52) U.S. Cl. CPC B62D 55/15; B62D 55/088

(57) ABSTRACT

An improved mounting block and bushing provides greater protection against accumulation of dirt, water and other contaminants that often result in cracking, abrasion and damage to heavy equipment. The assembly also permits removal and replacement of one or more seals that assist in the objectives described herein. The improved apparatus may be provided with a new piece of equipment, or may alternatively be provided to retrofit an existing piece of equipment.

### FIELD OF THE INVENTION

The field of the invention generally relates to track and crawler style machinery, and more specifically to an improved wheel/roller and axle assembly that provides improved sealing, maintenance and reliability.

### BACKGROUND OF THE INVENTION

Heavy machinery used in excavation/extraction of soil, minerals, etc. are commonly found in the fields of construction, mining, oil and gas, forestry, and the like. These types of machinery are well known in the art, and may comprise a crawler assembly for supporting the weight of components associated with such equipment (and the weight of any load borne by the equipment). In general, a crawler or track-based piece of heavy machinery typically comprises a frame, a track, a plurality of links or shoes coupled together and supported for movement relative to the frame along a direction of travel, a sprocket, and a guide rail. Track type assemblies typically use a continuous track, frequently employing chains and belts. A drive wheel transmits power to the crawler track, while a non-powered idler assembly guides the continuous track. The assembly typically includes an idler wheel. Idler assemblies may also serve to bear a portion of the weight of the machinery, and are therefore an important component in the entire assembly.

Due in part to their continuous operation and in part to the harsh environments where these types of machines are used, the above-described components are historically subject to extreme wear over time. More specifically, the weight of the equipment and any loads supported by the equipment are transmitted to the components of the idler wheel assembly, which wear down and/or deform through repetitive use. In addition, the often hard, rocky surfaces the shoes are exposed to may cause further wear and deformation to the components as well as introduce sand, dirt, and debris to the assembly. During the winter season, water can penetrate the seals associated with the idler wheel and shaft, then freeze, causing significant damage to the assembly. These problems require periodic repairs and replacement of components resulting in downtime for the equipment, which can cost tens to hundreds of thousands of dollars in repairs alone. The loss in productivity is often measured in the hundreds of thousands of dollars.

The prior art has not revealed a suitable solution to problems associated with wear on these assemblies, particularly as it relates to the introduction of water, sand, dirt, debris and other undesirable contaminants to the interior of the idler wheel and shaft during operation. Accordingly, the present invention solves these and other problems associated with the prior art, in part by providing a system for reducing undesired damage to the idler wheel and shaft, reducing wear and friction, avoiding attraction of dirt, debris or fluids that can cause interference, and allowing for faster, more accurate and safer installation of components of the system described herein. Other advantages and benefits will become apparent after reviewing the Summary and Detailed Description sections below.

### SUMMARY OF THE INVENTION

U.S. patent application Ser. No. 15/959,117, filed on Apr. 20, 2018 and issued as U.S. Pat. No. 10,843,749 on Nov. 24, 2020, which is commonly owned by the Applicant, is hereby incorporated by reference in its entirety for the purpose of supplementing this disclosure, pursuant to 35 U.S.C. § 112. U.S. Pat. No. 10,843,749 is specifically incorporated for the purpose of describing heavy equipment used for mining, oil and gas and related fields. By way of example but not limitation, such equipment includes crawler and track style equipment comprising a straddle mount idler wheel and shaft assembly.

Idler assemblies generally include an idler wheel engaged with a crawler track along an outer diameter. A central idler shaft, mounted between arms or extensions of a front portion of a crawler frame, passes through a central bore of the idler wheel. The shaft is then received by bearing blocks within the crawler arms. A journal bearing, or bushing, is fitted between the bearing blocks and the shaft, creating a bearing surface in which the shaft and idler wheel rotate within. This is known as a straddle mounted idler assembly since the idler wheel is “straddled” by the bearing surfaces on either side of the crawler frame extensions. The straddle mounted idler design is fundamentally different from a standard dead axle design. In a dead axle design, the shaft is fixed from rotating, while the idler wheel receives a journal bushing. The bearing surface is centered in the crawler frame extensions, and the idler wheel rotates about the shaft. In order for the shaft and wheel to rotate integrally amongst the bearing surface they must be coupled rotationally. Typically splines or keys are used. In a typical application, the idler wheel is fixed or locked to the idler shaft rotationally, but not axially. In other assemblies, the idler wheel and shaft are coupled rotationally via a standard key on the shaft and corresponding keyway in the wheel.

According to embodiments, one aspect of the present disclosure is to improve upon the efficiency and longevity of idler wheel and lower roller assemblies and related system components.

In one aspect, the present disclosure relates to an improvement to existing idler wheel or roller assembly, wherein one or more seals are provided in a pathway between two or more components of the assembly. In one embodiment, one or more seals are preferably received between two components, one of which is removeable, such that seals may be easily replaced during routine maintenance or as needed from a periodic inspection.

In one aspect, the pathway comprises a labyrinth with multiple angles, variations and/or breaks in the direction of the pathway for preventing or reducing entry of contaminants.

In another aspect, a matching counterbore is provided to one or more adjustment blocks associated with a lower roller assembly. In embodiments, a counterbore into the assembly is further introduced to accommodate the improvement. The counterbored sections are configured to receive an insert, which in a preferred embodiment is comprised of two separate pieces press-fit together.

In another aspect, the improvement relates to a two-piece insert for a roller assembly that carries at least one seal. The at least one seal is preferably received between the two pieces of the insert and is thereby removeable and replaceable during routine maintenance or as needed from a periodic inspection.

In yet another aspect, the two-piece insert comprises a close coupling, wherein a first piece is matched with a second piece, providing a complementary mating or matching engagement. In embodiments, the first piece and second piece are closely coupled, while providing a interlaced pathway or labyrinth between the first piece and the second piece. This labyrinth between the two pieces may be oriented in a way to prevent or prohibit entry of sand, dirt, gravel, dust, debris and other undesirable contaminants. The labyrinth, in one aspect, may prevent or prohibit introduction of a liquid, including water, from penetrating the two-piece insert beyond the seal.

According to yet another aspect, the assembly may further comprise an integral face seal installed into one or more adjustment blocks associated with the assembly. The adjustment blocks may receive a duo cone seal to further prohibit ingress of fluid, such as water.

In yet another aspect, the improvement comprises securing means for attaching the press-fit insert to the assembly. The securing means may comprise a plurality of cap screws. In one embodiment, the plurality of cap screws comprises at least six cap screws, which may be socket head cap screws.

In yet another aspect, one or more seals provided with the improvement may comprise fill ports, which are selectively closed or opened to either prohibit the loss of oil or permit the introduction of oil to the wheel/roller and axle assembly. In this manner, oil may be introduced and retained within the seal cavity to ensure proper lubrication.

In one aspect, the improvement is provided as a new assembly for enjoying the benefits of the present disclosure. In another aspect, the improvement is provided as a redesign or retrofit to existing idler wheel and shaft assemblies or lower roller assemblies, wherein the existing components are machined in order to receive the counterbores, the press-fit inserts and seals described above. In yet another aspect, these improvements may be customized for a certain application or piece of machinery or the surrounding environment of the machinery.

According to one embodiment, the present disclosure relates to an assembly, comprising: an axle; a lower roller coupled to the axle; a bushing surrounding the axle; a pair of retention blocks positioned about the axle and adjacent a first and a second sidewall of the lower roller; a first seal; wherein the retention blocks and the bushing comprise a plurality of adjacent, complementary surfaces to form two pathways between the retention blocks and the bushing; wherein each of the two pathways comprise a chamber for housing the first seal; and wherein the retention blocks are selectively removeable to access the pathways for maintenance on the assembly or replacement of the first seal.

In another aspect, the assembly comprises a first seal and a second seal. In another aspect, one of the first and second seals is a V-ring seal. In another aspect, one of the first and second seals is a conical or cone seal. In another aspect, one of the first and second seals is a face seal.

In another aspect, the assembly is duplicated for use with the same or a different crawler or track-type undercarriage for supporting a piece of heavy machinery.

According to another aspect, one or more components of the assembly may be countersunk to the axle. In yet another aspect, one or more components may be countersunk in a lower roller.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. Further details and other features will become apparent after review of the following Detailed Description and accompanying drawing figures.

One having skill in the art will appreciate that embodiments of the present disclosure may be constructed of materials known to provide, or predictably manufactured to provide the various aspects of the present disclosure. These materials may include, for example, steel, steel alloy, stainless steel, iron, cast iron, aluminum, aluminum alloy, chromium alloy, graphite, and other metals or metal alloys. The sealing material may include, for example, rubber, polyurethane, polyethylene, PTFE, UHMW, carbon fiber, resinous materials, and other plastic or synthetic materials.

As utilized herein, the phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being approximations which may be modified in all instances as required for a particular application of the novel apparatus described herein.

The term “a” or “an” entity, as used herein, refers to one or more of that entity. As such, the terms “a” (or “an”), “one or more” and “at least one” can be used interchangeably herein. The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves. For the purpose of supplementing the written description for the present disclosure, the following U.S. patents and pending applications incorporated by reference: U.S. Pat. Nos. 10,865,541, 10,843,749 and U.S. Provisional Application No. 62/986,090 filed on Mar. 6, 2020.

The Summary is neither intended, nor should it be construed, as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description, and no limitation as to the scope of the present disclosure is intended by either the inclusion or non-inclusion of elements or components when describing certain embodiments herein. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure, and together with the Summary and the Detailed Description serve to explain the principles of these embodiments. In certain instances, details that are not necessary for an understanding of the disclosure or that render other details difficult to perceive may have been omitted. It should be understood, of course, that the present disclosure is not necessarily limited to the particular embodiments illustrated herein. Additionally, it should be understood that the drawings are not necessarily to scale.

In the drawings:

FIG. 1 is a front perspective view of a prior art idler wheel assembly;

FIG. 2 is a front perspective view of an enhanced idler wheel assembly according to embodiments of the present disclosure;

FIG. 3A is a right side sectional view of the enhanced idler wheel assembly of FIG. 2;

FIG. 3B is a detailed sectional view of the enhanced idler wheel assembly of FIG. 3A;

FIG. 4 is a front perspective view of an enhanced lower roller assembly according to an embodiment of the present disclosure;

FIG. 5 is a side elevation view of the assembly of FIG. 4;

FIG. 6 is a sectional view of the assembly of FIG. 5;

FIG. 7 is a partial detail view of the assembly of FIG. 6;

FIG. 8 is another side elevation view of the assembly of FIG. 4;

FIG. 9 is a sectional view of the assembly of FIG. 8; and

FIG. 10 is a partial detail view of the assembly of FIG. 9.

The following is a list of components and their associated reference number:

| Ref. # | Component |
|---|---|
| 1 | Lower Roller |
| 2 | Bushing |
| 3 | Shaft/Axle |
| 4 | Block |
| 5 | Seal |
| 6 | V-ring Seal |
| 7 | Keeper Bar |
| 8 | Capscrew |
| 9 | Groove |
| 10 | Bolt |
| 11 | Washer |
| 12 | O-ring |
| 21 | Idler Assembly (prior art) |
| 22 | Inboard Arm |
| 24 | Outboard Arm |
| 25 | Front Aperture |
| 26 | Outboard Arm Face |
| 30 | Idler Wheel |
| 31 | Bore (of Idler Wheel) |
| 50 | Outboard Retainer Assembly |
| 101 | Idler Assembly Axle |
| 102 | Face Seal |
| 103 | Seal |
| 104 | Keeper Bar(s) |
| 109 | End Cap |
| 112 | Idler Wheel |
| 113 | Pedestal |

Similar components and/or features may have the same reference number. Components of the same type may be distinguished by a new reference number. If only the reference number is used, the description is applicable to any one of the similar components having the same reference number.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of installing, assembling and operating the system is described in detail according to the preferred embodiment, without attempting to describe all of the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

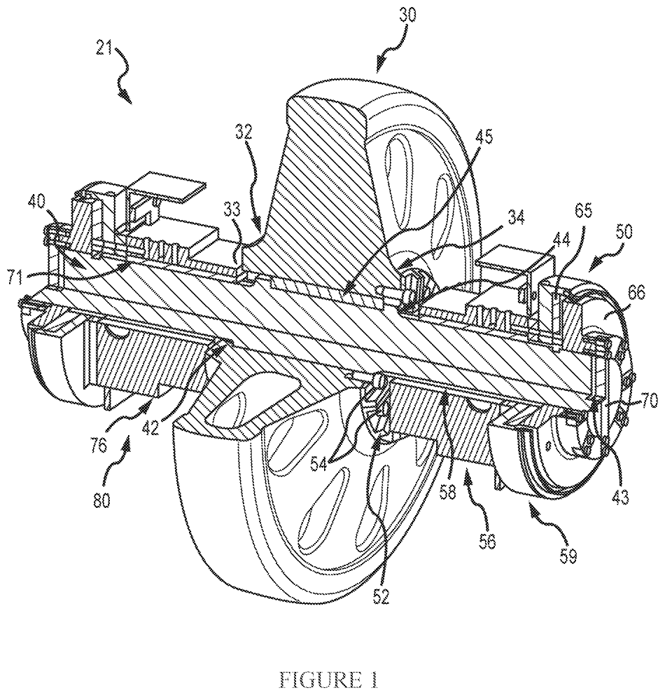

In this Detailed Description, reference is made to the embodiments depicted in FIGS. 1-10. According to one embodiment, the system may be used with several types of heavy equipment. By way of example but not limitation, the present disclosure may be incorporated with any existing idler wheel and shaft assembly, or may be provided as a new assembly.

Referring now to FIG. 1, an exemplary idler wheel assembly according to the prior art is shown. An undercarriage (a term known to those of ordinary skill in the art) is typically used in pairs on adjacent sides of track type heavy equipment machine. Each paired undercarriage may comprise a crawler frame and an idler assembly 21. The crawler frame is preferably coupled to continuous tracks, i.e. chains or belts, which wrap around the undercarriage and engage an idler wheel 30. The continuous tracks travel in a continuous loop around the crawler frame of the undercarriage when the machine is in motion. A drive wheel transmits power to the continuous track, while an idler wheel 30 of a non-powered idler assembly 21 guides the continuous track. The continuous track(s) travel linearly via the lower rollers positioned on the bottom portion of the crawler frame. The lower rollers carry the weight of the machine and allow the entire machine to propel in the forward or reverse direction.

An inboard arm 22 and an outboard arm 24 are formed on a distal end of the crawler frame 20. The inboard arm 22 and the outboard arm 24 together define a front aperture 25 of the crawler frame 20. An idler wheel 30 is disposed between the inboard arm 22 and the outboard arm 24 and at least partially within the front aperture 25. The idler wheel 30 operates within the front aperture 25. The term “inboard” means inside of an element or a machine or toward the inside of an element or machine. The term “outboard” means outside of an element or a machine or toward the outside of an element or machine. As an example, for a typical crawler machine with two adjacent undercarriages, such that the inboard arm 22 faces the interior of the machine, and the outboard arm 24 faces an exterior of the machine.

The idler wheel 30 preferably includes a bore 31 formed through a central axis of the idler wheel 30. An idler shaft 40 passes through the bore 31. The idler shaft 40 also passes through respective windows or openings on each of inboard arm 22 and outboard arm 24. FIG. 1 depicts several other components of a crawler assembly that will be familiar to one of ordinary skill in the mining and heavy machinery arts.

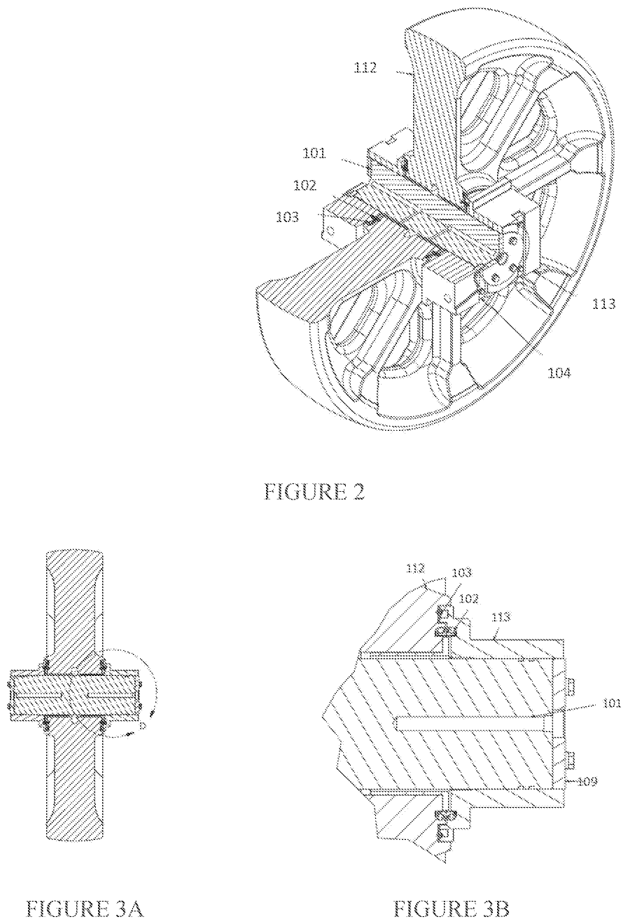

One embodiment of the present disclosure relates to an enhanced idler wheel assembly as shown in FIGS. 2 and 3A-3B. Referring to FIG. 2, the assembly may comprise an idler axle 101, enhanced idler wheel 112, and pedestal 113 that combine to provide at least one narrow pathway, which preferably houses a face seal 102 and V-ring seal 103. The seals 102, 103 may selectively permit introduction of oil or other lubricants as described in detail below. In addition, the axle 101 preferably comprises a slot or groove that runs substantially parallel to and/or perpendicular to the main axis of the axle 101 and acts as a weeping point from excess fluid or debris. Keeper Bar(s) 104 may be held in place by screws or equivalent fasteners suitable for easy removal such that pedestal 113 may be removed and the narrow pathway may be accessed.

FIGS. 3A-3B depict additional aspects of the present disclosure. Axle 101 may be fitted with two end caps 109, which preferably abut pedestal 113. As best seen in FIG. 3B, the seals 102, 103 are contained within a labyrinth-like pathway that includes multiple 90 degree turns. The seals 102, 103 are preferably contained in the closely contacting areas between idler wheel 112 and pedestal 113. This arrangement provides ease of access and replacement from time to time, while simultaneously prohibiting foreign contaminants from reaching the axle 101.

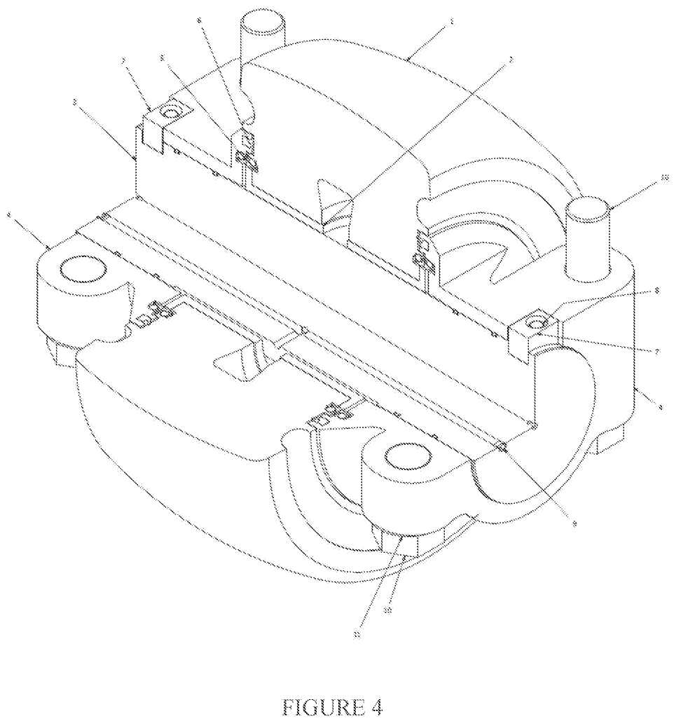

Referring now to FIG. 4, a perspective view of the improvements to a lower roller assembly are shown. Here, the assembly may comprise a lower roller 1 coupled to lower roller axle 3, which in turn is coupled to an improved block 4. The assembly may be joined by rotationally mounting lower roller 1 to lower roller axle 3 and coupling that assembly to block 4 by, by way of example, using bolts 10 with washers 11 into threaded openings in the block 4. In embodiments, the shaft or axle 3 may be milled to receive one or more keeper bar(s) 7, which are secured to axle 3 by a bolt or capscrew 8, for example. Lower roller 1 may also be counterbored to receive an insert as described in the Summary above, which is shown in FIG. 4 at the junction of block 4 and lower roller bushing 2. Lower roller assembly may be further retained to the crawler frame by one or more bolts 10 (in addition to keeper bars 7).

The seam or gap between block 4 and lower roller bushing 2 creates a pathway or labyrinth, wherein one or more seals may be housed. For example, seal 6 and/or seal 5 may be employed with the improved assembly to collect debris and prevent unwanted contamination to the lower roller 1 and axle 3 coupling. In embodiments, the seal 6 may be a v-ring type seal while the seal 5 may be a face seal or cone seal. The seals 5, 6 may selectively permit introduction of oil or other lubricants as described in detail below. In addition, the axle 3 preferably comprises a slot or groove 9 that may serve as a fill port for oil or other lubricants, or alternatively acts as a weeping point from excess fluid or debris. The groove 9 may receive a plug to selectively close the groove during normal operation of the assembly.

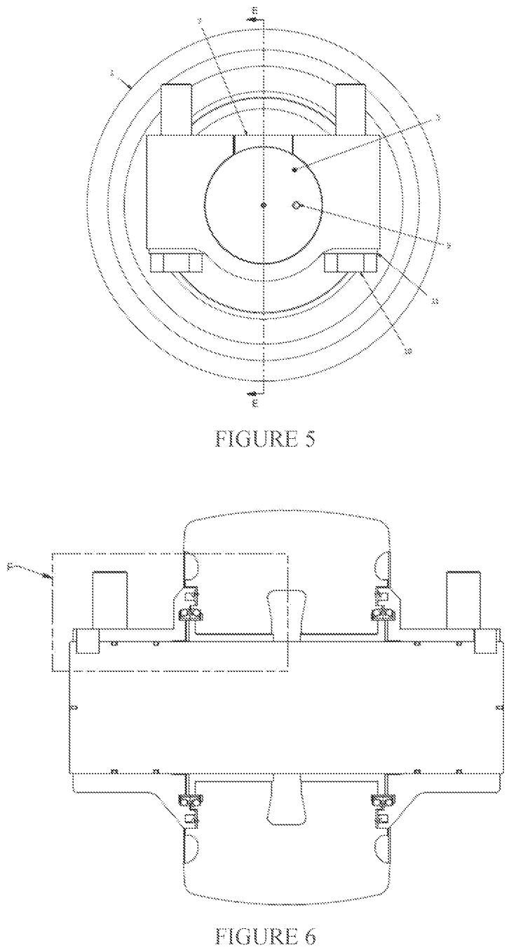

FIG. 5 depicts a side elevation view of the lower roller assembly of FIG. 4. The keeper bars 7 are preferably held in place by capscrews 8 or an equivalent fastener that is suitable for easy removal. The axle 3 is concentric with the lower roller 1 and the x-axis of the block 4 to provide for proper balancing during rotational movement of the lower roller 1. Two large bolts 10 are shown on either side to secure the lower roller 1 to the assembly.

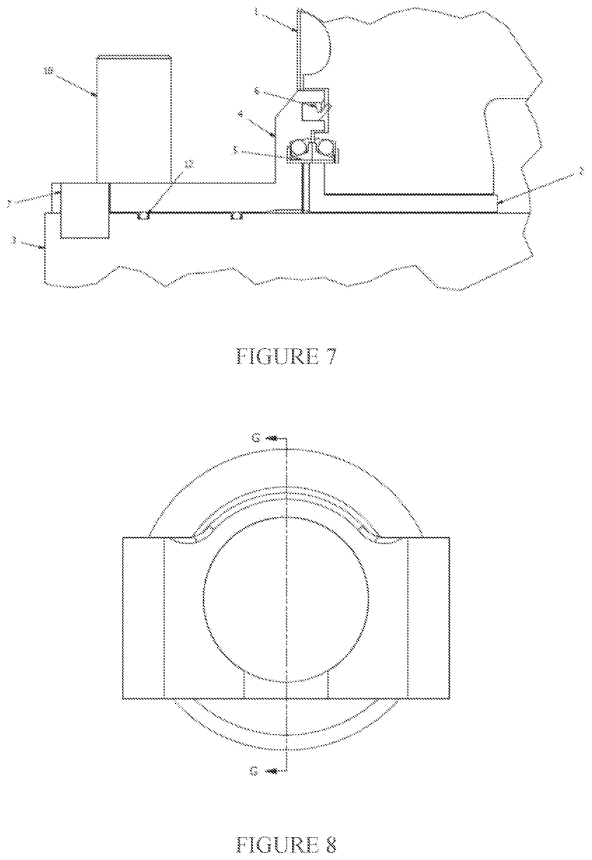

FIG. 6 illustrates a sectional view of the lower roller assembly shown in FIG. 5. In this view, the pathway or labyrinth between the bushing 2 and the block 4 is best shown. In a typical assembly, there are four pathways formed by the improved assembly described above in relation to FIGS. 4-6. A detail area F is highlighted in this figure to offer an enlarged view of the pathways, which are shown in FIG. 7. FIG. 7 depicts a detail view of the pathway along the lower roller 1 and between the block 4 and bushing 2. The V-ring seal 6 and cone seal 5 are between the beginning of this pathway and the axle 3. The axle 3 may further comprise a plurality of O-rings 12 to facilitate the close coupling between these components.

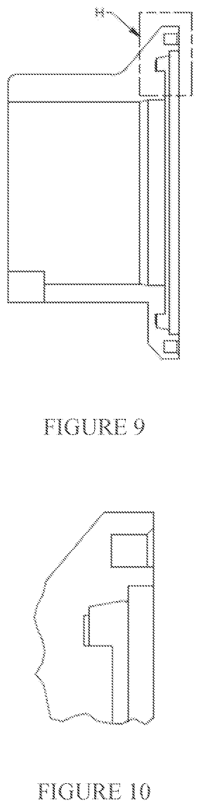

Referring to FIG. 8, another side elevation view of the lower roller assembly is shown. Turning now to FIGS. 9-10, sectional and detail views are shown to illustrate various aspects of the present disclosure. In FIG. 9, an adjustment block and associated seal is shown. In embodiments, the seal may be a mechanical face seal. The seal may be fabricated from Hardox® 450 or equivalent material, which provides superior wear properties. In embodiments, the seal(s) are easily replaceable, and deteriorated seals may be removed and discarded in favor of a new seal without experiencing significant downtime.

The present disclosure provides an effective and relatively quick manner of upgrading or enhancing a track-based assembly such as the ones described above, while further reducing wear and potential damage to components throughout the life of the equipment. Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims).

To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g. the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An assembly, comprising:
an axle;
a lower roller coupled to the axle for permitting rotational movement of the lower roller about the axle;
a bushing surrounding an outer circumference of the axle;
a pair of retention blocks positioned about the axle and adjacent a first and a second sidewall of the lower roller;
at least a first seal;
wherein the retention blocks and the bushing comprise a plurality of adjacent, complementary surfaces to form two pathways between the retention blocks and the bushing;
wherein each of the two pathways comprise a chamber for housing the at least one first seal; and
wherein the retention blocks are selectively removeable to access the pathways for maintenance on the assembly or replacement of the at least one first seal.

2. The assembly of claim 1 further comprising at least one second seal.

3. The assembly of claim 2, wherein the at least one second seal is a V-ring seal.

4. The assembly of claim 1, wherein the at least one first seal is conical.

5. The assembly of claim 4, wherein the at least one first seal comprises at least one selectively removeable plug in the face of the at least one seal.

6. The assembly of claim 1 further comprising a pair of bars secured to the axle, each of the pair of bars positioned to abut one of the pair of retention blocks.

7. The assembly of claim 6, wherein the pair of bars are countersunk in the axle.

8. The assembly of claim 1, wherein the axle comprises a narrow groove parallel to the longitudinal axis of the axle.

9. The assembly of claim 8 further comprising at least a second groove oriented to intersect the narrow groove at one end and the outer circumference of the axle at another end.

10. The assembly of claim 8 further comprising at least a third groove oriented to intersect the narrow groove at one end and the outer circumference of the axle at another end.

11. The assembly of claim 8, wherein the narrow groove is selectively sealed with a plug.

12. The assembly of claim 1, wherein the retention block is at least partially countersunk in the sides of the roller wheel.

13. The assembly of claim 1, wherein the at least one first seal is selectively removeable after removing at least one of the retention blocks.

14. The assembly of claim 2, wherein the at least one second seal is selectively removeable after removing at least one of the retention blocks.

15. The assembly of claim 1, wherein the pathway comprises at least two 90 degree turns.

16. The assembly of claim 1, wherein the pathway comprises at least three 90 degree turns.

17. The assembly of claim 1 further comprising at least one O-ring positioned between the retention blocks and the axle.

18. The assembly of claim 1, wherein the assembly is coupled to a crawler frame.

19. The assembly of claim 18, wherein the assembly is duplicated to provide the assembly and a second assembly.

20. The assembly of claim 19, wherein the second assembly is attached to the crawler frame.
